(19) United States
(12) Patent Application Publication
(10) Pub. No.: US 2015/0069245 A1
(43) Pub. Date: Mar. 12, 2015

(54) HUMAN BODY DETECTOR, HUMAN BODY-DETECTING METHOD, ELECTRIC DEVICE, AND IMAGE FORMING APPARATUS

(71) Applicant: Takeshi Nagahisa, Osaka (JP)

(72) Inventor: Takeshi Nagahisa, Osaka (JP)

(73) Assignee: RICOH COMPANY, LTD., TOKYO (JP)

(21) Appl. No.: 14/461,543

(22) Filed: Aug. 18, 2014

(30) Foreign Application Priority Data
Sep. 10, 2013 (JP) 2013-187465

(51) Int. Cl. G01V 8/10

(52) U.S. Cl. CPC G01V 8/10
USPC 250/340; 250/338.1

(57) ABSTRACT

A human body detector is disclosed. The human body detector comprises an infrared sensor which detects a light amount change of infrared rays which enter from a detection target area, and a controller which determines the presence or absence of a human body in the detection target area according to the light amount change of the infrared rays. The infrared sensor is configured to detect the light amount change of the infrared rays which enter from a plurality of cell sections which are formed by dividing the detection target area, and the controller is configured to identify an outer peripheral area and an inside area, and determine the presence and absence of the human body in the detection target area.

### CROSS-REFERENCE TO RELATED APPLICATION

The present application is based on and claims priority from Japanese Patent Application No. 2013-187465, filed on Sep. 10, 2013, the disclosure of which is hereby incorporated by reference herein in its entirety.

### BACKGROUND

### Field of the Invention

The present invention relates to a human body detector using an infrared sensor, a human body-detecting method, an electric device including the human body detector, and an image-forming apparatus including the human body detector.

In reaction to recent social conditions, various electric devices, office machines and so on (hereinafter, referred to as an electric device) having an energy conservation function have been developed, manufactured, and distributed. The electric device includes inside thereof a pyroelectric-type infrared sensor, for example. When the output voltage signal from the pyroelectric-type infrared sensor is under a threshold which is predetermined according to design, the electric device determines that a user is absent there around, and enters into a static mode (for example, power saving mode). On the other hand, when the output voltage signal from the infrared sensor exceeds the threshold, the electric device determines that the user is standing near the electric device, and immediately changes its mode to an operating mode from the static mode. In fact, an electric device is already known in which energy saving is realized by setting the operating mode only when the user comes closer to the device, and setting the static mode when the user is not standing around the device (for reference, see Japanese Patent Laid-open Publication No. 06-242226 and Japanese Patent Laid-open Publication No. 2009-288498).

An optimum electric power-control to achieve energy conservation can be realized if a user who is standing in an area adjacent to an electric device for operation can be detected. However, the pyroelectric-type infrared sensor has a problem derived from its characteristic feature such that it is difficult to detect the static state of the user in a detection target area. When the user stands in front of the electric device for operating with no substantial movement (or with very small movement which cannot be detected by a pyroelectric-type infrared sensor), the electric device suddenly changes its mode from the operating mode to the static mode even though the user is still using the device. Thus, such a sudden change significantly decreases the user-friendliness of the device.

### SUMMARY

The present invention has been made in view of the above problem, and an object of the present invention is to provide a human body detector including an infrared sensor, which can reliably detect the presence of a human body in a designated area.

A human body detector according to embodiments of the present invention includes, an infrared sensor which detects a light amount change of infrared rays which enter from a detection target area, and a controller which determines the presence or absence of a human body in the detection target area according to the light amount change of the infrared rays, wherein the infrared sensor is configured to detect the light amount change of the infrared rays which enter from a plurality of cell sections which are formed by dividing the detection target area, and arranged two-dimensionally in the detection target area, and

the controller is configured to identify an outer peripheral area including cell sections provided along a portion in the outer periphery of the detection target area through which the human body can pass, and an inside area including cell sections other than those in the outer peripheral area, determine the presence of the human body in the detection target area when the light amount change of the infrared rays which enter from the cell sections in the inside area is detected, and determine the absence of the human body in the detection target area when the light amount change of the infrared rays is not detected for a predetermined period in all of the cell sections after the light amount change of the infrared rays which enter from the cell sections in the outer peripheral area is detected.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a block chart illustrating a configuration of an electric device 10 including a human body detector according to a first embodiment of the present invention.

FIG. 2 is a side view illustrating a configuration of infrared sensors 11 and 12 shown in FIG. 1.

FIG. 3 is an upper surface view illustrating a detailed configuration of a circuit substrate 22 shown in FIG. 2.

FIG. 4 is a schematic view illustrating viewing fields 1 to 4 of the infrared sensor 11 shown in FIG. 1.

FIG. 5 is a block chart illustrating a detailed configuration of a signal-processing circuit 32 shown in FIG. 3.

FIG. 6 is a waveform chart illustrating the behavior of infrared ray-sensing elements S1 to S4 shown in FIG. 3.

FIG. 7 is a schematic view illustrating an aspect in which a human body 51 enters into the viewing field 1 of the infrared sensor 11 shown in FIG. 1.

FIG. 8 is a waveform chart illustrating output voltages V1-1 to V1-4 of the infrared ray-sensing elements S1 to S4 under the condition as shown in FIG. 7.

FIG. 9 is a timing chart illustrating the behavior of a signal-processing circuit 32 under the condition as shown in FIG. 7.

FIG. 10 is a schematic view illustrating aspects in which the human body 51 enters into, stops, passes through the viewing fields 1 to 4 of the infrared sensor 11 shown in FIG. 1, and an aspect in which the human body 51 travels away from the infrared sensor 11.

FIG. 11 is a waveform chart illustrating the output voltage V1-1 to V1-4 of the infrared ray-sensing elements S1 to S4 in the aspect in which the human body 51 stops in the viewing fields 1 to 4 and travels away from the infrared sensor 11 under the condition as shown in FIG. 10.

FIG. 12 is a waveform chart illustrating the output voltage V1-1 to V1-4 of the infrared ray-sensing elements S1 to S4 in the aspect in which the human body 51 passes through the viewing fields 1 to 4 under the condition as shown in FIG. 10.

FIG. 13 is a schematic view illustrating the aspect in which the human body 51 enters into the detection target area of the infrared sensors 11 and 12 shown in FIG. 1

FIG. 14 illustrates output signals of the infrared sensors 11 and 12 in an aspect in which the human body 51 travels in an outer peripheral area under the condition as shown in FIG. 13.

FIG. 15 illustrates output signals of the infrared sensors 11 and 12 in an aspect in which the human body 51 passes through both outer peripheral area and inside area under the condition as shown in FIG. 13.

FIG. 16 illustrates output signals of the infrared sensors 11 and 12 in an aspect in which the human body 51 travels in the inside area under the condition as shown in FIG. 13.

FIG. 17 illustrates output signals of the infrared sensors 11 and 12 in an aspect in which the human body 51 stands still in the inside area under the condition as shown in FIG. 13.

FIG. 18 is a flowchart illustrating a human body-detecting process which is performed by a sensor controller 13 shown in FIG. 1.

FIG. 19 is a block chart illustrating a configuration of an electric device 10 including a human body detector according to a modified example of the first embodiment of the present invention.

FIG. 20 is a block chart illustrating a configuration of an electric device 10A including a human body detector according to a second embodiment of the present invention.

FIG. 21 is a schematic view of an image-forming apparatus according to an example of the present invention.

### DETAILED DESCRIPTION OF THE PREFERRED EMBODIMENT

Hereinafter, with reference to the drawings, embodiments of the present invention will be described.

### First Embodiment

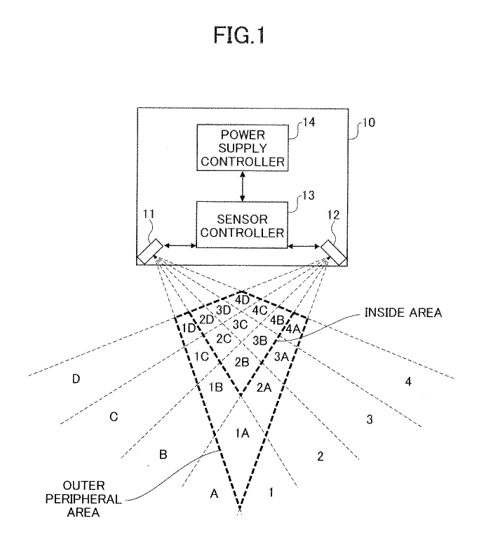

FIG. 1 is a block chart illustrating a configuration of an electric device 10 including a human body detector according to the first embodiment of the present invention. The electric device 10 includes a human body detector including infrared sensors 11 and 12 and a sensor controller 13. The human body detector has a detection target area (area surrounded by thick dotted line in FIG. 1) which is defined according to detection ranges of the infrared sensors 11 and 12. In the aspect shown in FIG. 1, the detection target area is adjacent to the electric device 10 and expands in the horizontal direction in relation to the ground surface. In FIG. 1, the overhead view of the electric device 10 and its detection target area are shown. The infrared sensors 11 and 12 detect the light amount change of the infrared rays which enter from the detection target area. The sensor controller 13 determines the presence or absence of the human body 51 in the detection target area based on the light amount change of the infrared ray. The electric device 10 further includes a power source controller 14, and the power source controller 14 sets the electric device 10 to the operating mode or the static mode under the control of the sensor controller 13 when the electric device 10 is turned on. The sensor controller 13 sets the electric device 10 to the operating mode when it determines the presence of the human body in the detection target area, and sets the electric device 10 to the static mode when it determines the absence of the human body in the detection target area.

The configuration of the human body detector in FIG. 1 will be described as follows.

The infrared sensors 11 and 12 are configured to detect the light amount change of the infrared rays which enter from each of cell sections which are formed by segmenting the detection target area and are arranged two-dimensionally in the detection target area. The infrared sensor 11 includes a first infrared sensor array including a plurality of infrared ray-sensing elements having first viewing fields 1 to 4 which are different from, and are adjacent to each other. For example, in the infrared sensor 11, the viewing fields 1 to 4 are configured by segmenting the detection target area in a radial fashion. The infrared sensor 12 includes a second infrared sensor array including a plurality of second infrared ray-sensing elements having second viewing fields A to D which are different from, and are adjacent to each other. For example, in the infrared sensor 12, the viewing fields A to D are configured by segmenting the detection target area in a radial fashion. The infrared sensors 11 and 12 are disposed in a chassis of the electric device 10 so as to have a predetermined distance therebetween. The first viewing fields 1 to 4 intersect with the second viewing fields A to D. Each cell section is formed such that one of the first viewing fields 1 to 4 intersects with one of the second viewing fields A to D.

The sensor controller 13 identifies an outer peripheral area including cell sections which are arranged along a portion in the outer periphery of the detection target area in which the human body can pass through, and an inside area including cell sections other than the cell sections in the outer peripheral area. For example, the human body never passes through the portion adjacent to the chassis of the electric device 10 in the outer periphery of the detection target area shown in FIG. 1. Therefore, the cell sections arranged along such a portion are detected as the cell sections in the inside area, not in the outer peripheral area. In the aspect shown in FIG. 1, the sensor controller 13 identifies the cell sections included in the viewing field 1 which is the most distant from the infrared sensor 12 in the viewing fields 1 to 4 of the infrared sensor 11 as the cell sections in the outer peripheral area. The sensor controller 13 identifies the cell sections included in the viewing field A which is the most distant from the infrared sensor 11 in the viewing fields A to D of the infrared sensor 12 as the cell sections in the outer peripheral area. In addition, the sensor controller 13 identifies the cell sections which are not in the outer peripheral area as the cell sections in the inside area.

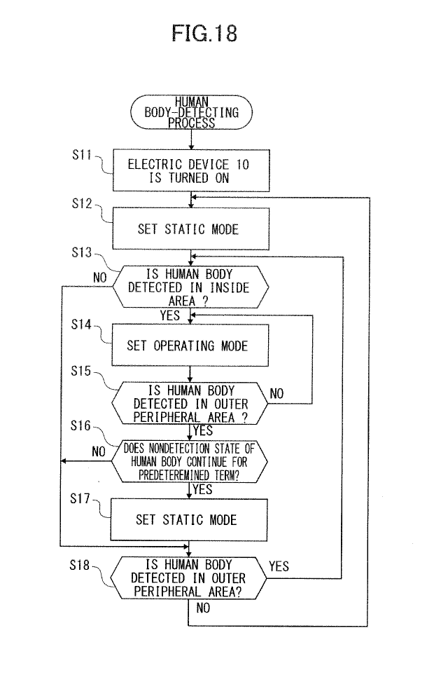

The sensor controller 13 performs a human body-detecting process as shown in FIG. 18 so as to determine the presence or absence of the human body in the detection target area. The sensor controller 13 determines the presence of the human body in the detection target area when the light amount change of the infrared rays which enter from the cell sections in the inside area is detected. The sensor controller 13 determines the absence of the human body in the detection target area when the light amount change of the infrared rays is not detected for certain periods in all of the cell sections after the light amount change of the infrared rays which enter from the cell sections in the outer peripheral area is detected. Thereby, even when the infrared sensors 11 and 12 do not detect the light amount change of the infrared rays because the user stands still in front of the electric device 10, the human body detector does not fail and detect absence of the human body, and thus, it can reliably detect the presence of the human body in the detection target area. The detailed description regarding the human body-detecting process will be made later with reference to FIG. 18.

The sensor controller 13 may determine the light amount change of the infrared rays which enter from the cell sections in the outer peripheral area when it detects the light amount change of the infrared rays in a plurality of adjacent cell sections (for example, two) of the cell sections in the outer peripheral area. Thereby, the light amount change of the infrared rays which enter from the cell sections in the outer peripheral area can be reliably detected. In this case, the viewing fields 1 to 4 and viewing fields A to D of the infrared sensors 11 and 12 are configured such that the human body occupies the two cell sections which are adjacent to each other when the human body stands in the outer peripheral area.

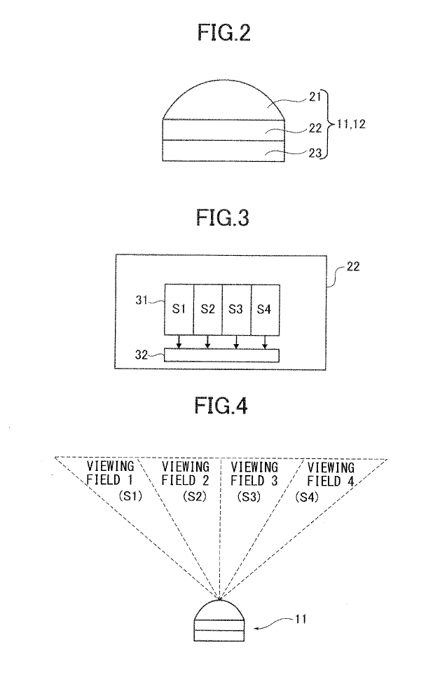

FIG. 2 is a side view illustrating the configuration of the infrared sensors 11 and 12 in FIG. 1. The infrared sensors 11 and 12 include a lens 21, a circuit substrate 22, and a package 23 which are configured integrally in layers. The lens 21 has an optical micro lens. The circuit substrate 22 includes an infrared ray sensing element and a signal-processing circuit (FIG. 3). The package 23 includes an insulant and an electric pole such as a supply terminal, an earth terminal, or an output signal terminal, which is provided so as to be exposed in part from the insulant. The circuit substrate 22 is sandwiched by the lens 21 and the package 23 for protection.

FIG. 3 is an upper surface view illustrating the detailed configuration of the circuit substrate 22 in FIG. 2. The circuit substrate 22 includes an infrared sensor array 31 including four infrared ray-sensing elements S1 to S4, and the signal-processing circuit 32. The infrared ray-sensing elements S1 to S4 are arranged linearly on the center part of the circuit substrate 22. The infrared rays which enter into the infrared sensors 11 and 12 from the detection target area are condensed by the lens 21 (FIG. 2) and enter into the infrared ray-sensing elements S1 to S4. The output voltages of each of the infrared ray sensing elements S1 to S4 are sent to the signal-processing circuit 32. The signal-processing circuit 32 is arranged in the area adjacent to the infrared sensor array 31.

FIG. 4 is a schematic view illustrating the viewing fields 1 to 4 of the infrared sensor 11 in FIG. 1. As described above, in the infrared sensor 11, the viewing fields 1 to 4 are configured by segmenting the detection target area in a radial fashion. Accordingly, the lens 21 and the infrared ray-sensing elements S1 to S4 of the infrared sensor 11 are configured so that the infrared rays from the viewing fields 1 to 4 enter into each of the infrared ray-sensing elements S1 to S4. For example, each of the viewing fields 1 to 4 does not share any portions to be configured exclusively. The infrared sensor 12 and the viewing fields A to D thereof have a similar configuration to the infrared sensor 11 and the viewing fields 1 to 4 thereof.

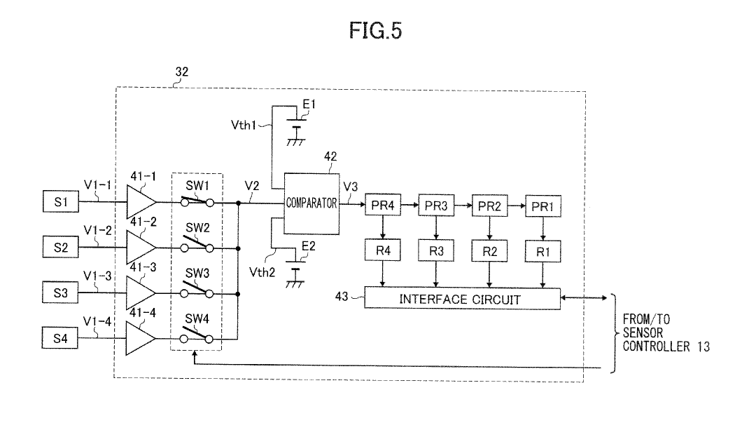

FIG. 5 is a block chart illustrating the detailed configuration of the signal-processing circuit 32 in FIG. 3. The signal-processing circuit 32 includes amplifiers 41-1 to 41-4, switches SW1 to SW4, standard voltage sources E1 and E2, a comparator 42, preregisters PR1 to PR4, registers R1 to R4, and an interface circuit 43.

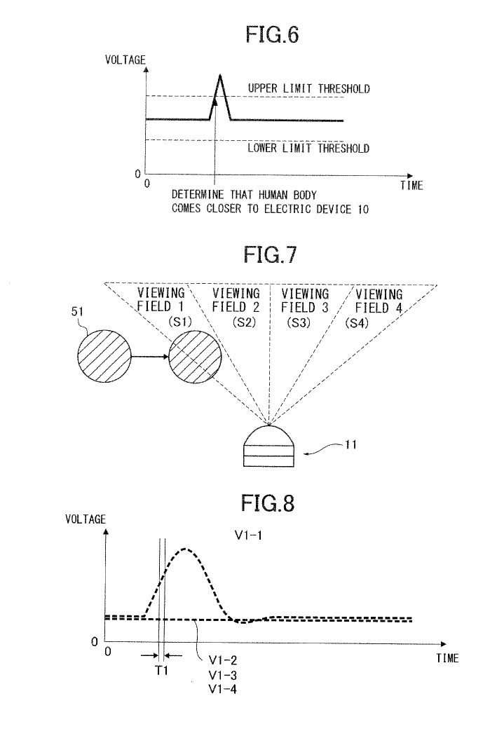

FIG. 6 is a waveform chart describing the behavior of the infrared ray-sensing elements S1 to S4 in FIG. 3. An increase or a decrease of the output voltages V1-1 to V1-4 of the infrared ray-sensing elements S1 to S4 when the light amount of infrared rays which enter from the viewing fields 1 to 4 (or viewing fields A to D) changes depends on the relationship between the temperature of the human body and the background temperature. When the human body temperature is lower than the background temperature, the output voltages V1-1 to V1-4 of the infrared ray-sensing elements S1 to S4 increase only in the case in which the light amount of the infrared rays which enter from the viewing fields 1 to 4 (or viewing fields A to D) changes, and the output voltages V1-1 to V1-4 exceed the predetermined upper limit threshold. On the other hand, when the human body temperature is higher than the background temperature, the output voltages V1-1 to V1-4 of the infrared ray-sensing elements S1 to S4 decrease only in the case in which the light amount of the infrared rays which enter from the viewing fields 1 to 4 (or viewing fields A to D) changes, and the output voltages V1-1 to V1-4 fall below the predetermined lower limit threshold.

Referring to FIG. 5 again, the output voltages V1-1 to V1-4 of the infrared ray-sensing elements S1 to S4 are amplified by the amplifiers 41-1 to 41-4. The switches SW1 to SW4 are connected to the output terminals of the amplifiers 41-1 to 41-4. The switches SW1 to SW4 operate under the control of the sensor controller 13, and always send only one signal from the output signals of the amplifiers 41-1 to 41-4. Hereinafter, the output signals of the amplifiers 41-1 to 41-4 which are sent to the comparator 42 are referred to as a detected voltage V2. The standard voltage source E1 generates the predetermined upper limit threshold voltage Vth1, and the standard voltage source E2 generates the predetermined lower limit threshold voltage Vth2. The comparator 42 determines whether the detected voltage V2 is within the range which is equal to or lower than the predetermined upper limit threshold voltage Vth1 and equal to or higher than the predetermined lower limit threshold voltage Vth2 (window range) as a window comparator. When V2 is higher than Vth1 or V2 is lower than Vth2, the output signal V3 of the comparator 42 becomes high level, and when V2 is equal to or higher than Vth2 and V2 is equal to or lower than Vth1, the output signal V3 of the comparator 42 becomes lower level. It depends on the relationship between the temperature of the human body and the temperature of the background whether the detected voltage V2 exceeds the upper limit threshold Vth1 or it falls below the lower limit threshold Vth2. In the case in which the human body temperature is lower than the background temperature, when the light amount of the infrared rays changes, the detected voltage V2 exceeds the upper limit threshold Vth1. In the case in which the human body temperature is higher than the background temperature, when the light amount of the infrared rays changes, the detected voltage V2 falls below the lower limit threshold Vth2. The switches SW1 to SW4 are turned on in order of “SW1 to SW2 to SW3 to SW4 to SW1 to . . . ”. Thereby, the comparator 42 evaluates whether the detected voltages V2 which correspond to each output voltage V1-1 to V1-4 of the infrared ray-sensing elements S1 to S4 are within the window range or not by time-sharing. The output signal V3 of the comparator 42 is stored in the preregisters PR4, PR3, PR2, and PR1. The preregisters PR4, PR3, PR2, and PR1 configure a shift register circuit. When the output signal V3 of the comparator 42 which corresponds to each output voltage V1-1 to V1-4 of the infrared ray-sensing elements S1 to S4 is stored in the preregisters PR1 to PR4, the data in the preregisters PR1 to PR4 is sent to the registers R1 to R4 by batch transmission. The interface circuit 43 transmits the data of the registers R1 to R4 to the sensor controller 13 by serial transmission when it receives the reading request signal from the sensor controller 13.

Hereinafter, with reference to FIGS. 7 to 12, the fundamental behavior of the human body detector in FIG. 1 will be described.

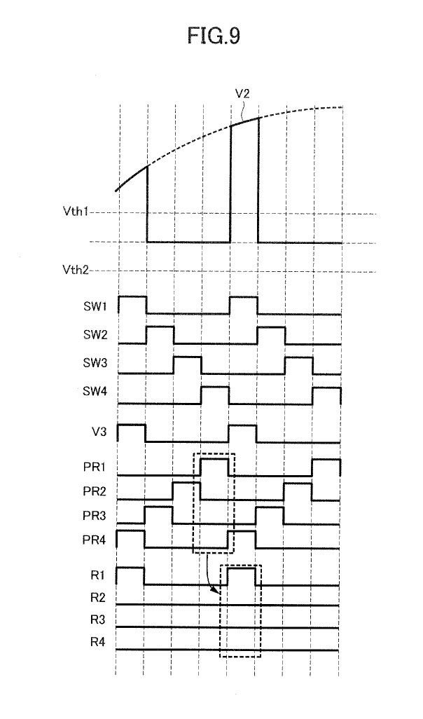

FIG. 7 is a schematic view illustrating an example in which the human body 51 enters into the viewing field 1 of the infrared sensor 11 in FIG. 1. FIG. 8 is a waveform chart illustrating the output voltage V1-1 to V1-4 of the infrared sensors S1 to S4 under the condition indicated in FIG. 7. As soon as the human body S1 enters into the viewing field 1, the light amount of the infrared rays which enter into the infrared ray-sensing element S1 changes, so the output voltage V1-1 of the infrared ray-sensing element S1 changes.

FIG. 9 is a timing chart describing the behavior of the signal-processing circuit 32 under the condition as indicated in FIG. 7. FIG. 9 illustrates the behavior of each signal in the signal-processing circuit 32 in a short period T1 shown in FIG. 8. In FIG. 9, “SW1 to SW4” indicate each signal which is provided from the sensor controller 13 toward the switches SW1 to SW4. The switches SW1 to SW4 close when the signals are at high level, and open when the signals are at low level. As described above, when the output signal V3 of the comparator 42 which corresponds to each output voltages V1-1 to V1-4 of the infrared ray-sensing elements S1 to S4 is stored in the preregisters PR1 to PR4, the data in the preregisters PR1 to PR4 is sent to the registers R1 to R4 by batch transmission. According to FIG. 9, only the detected voltage V2 which corresponds to the output voltage V1-1 of the infrared ray-sensing element S1 exceeds the upper limit threshold voltage Vth1, so that only the data of the resister R1 rises to be high level, and the data of the registers R2 to R4 falls to be low level.

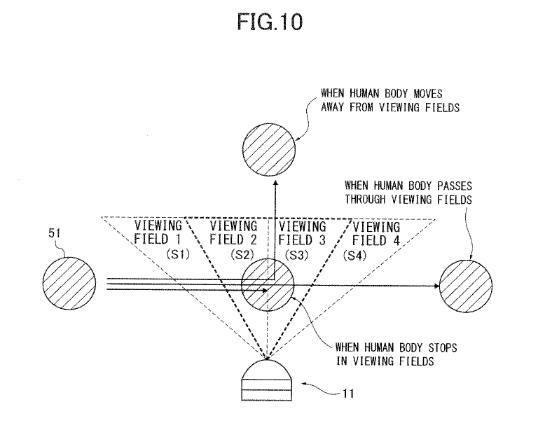

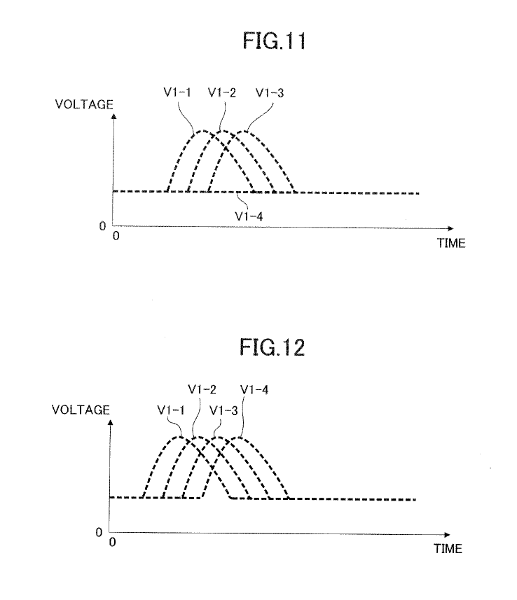

FIG. 10 is a schematic view illustrating aspects in which the human body 51 stops, passes through, or travels away from the infrared sensor 11 when the human body 51 enters into the viewing fields 1 to 4 of the infrared sensor 11 in FIG. 1. Herein, the experiment is provided so as to detect the presence of the human body 51 in the viewing fields 2 and 3 in FIG. 10. In the first aspect, the human body 51 enters into the viewing fields 2 and 3 through the viewing field 1, and stops. In the second aspect, the human body 51 passes through the viewing fields 1 to 4. In the third aspect, the human body 51 passes through the viewing field 1, enters into the viewing fields 2 and 3, and travels in the direction which is away from the infrared sensor 11. FIG. 11 is a waveform chart illustrating the output voltages V1-1 to V1-4 of the infrared ray-sensing elements S1 to S4 in the aspects in which the human body 51 stops or travels away from the infrared sensor 11 under the condition as indicated in FIG. 10. FIG. 12 is a waveform chart illustrating the output voltages V1-1 to V1-4 of the infrared ray-sensing elements S1 to S4 in an aspect in which the human body 51 passes through the viewing fields 1 to 4 under the aspect as shown in FIG. 10. According to FIG. 11, the aspect in which the human body stops and the aspect in which the human body travels away from the infrared sensor 11 cannot be distinguished only with the detected result of the infrared sensor 11. Therefore, it is difficult to detect the presence or absence of the human body 51 in the viewing fields 2 and 3. This is because the infrared sensor 11 in FIG. 11 can detect the motion of the human body 51 in the transverse direction but it is difficult to detect the motion of the human body 51 in the vertical direction easily.

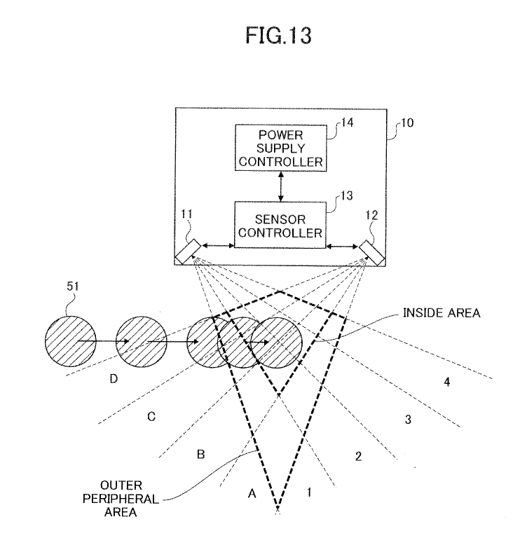

Subsequently, with reference to FIGS. 13 to 18, the human body-detecting method by using the human body detector in FIG. 1 will be described. Herein, the human body is expected to travel in the vertical direction in addition to traveling in the lateral direction.

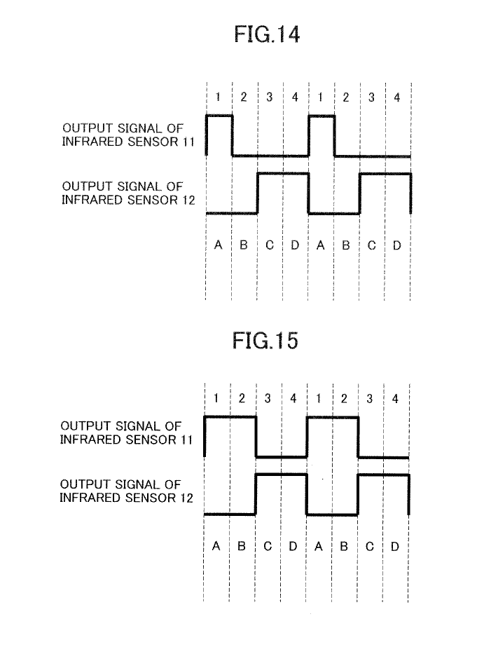

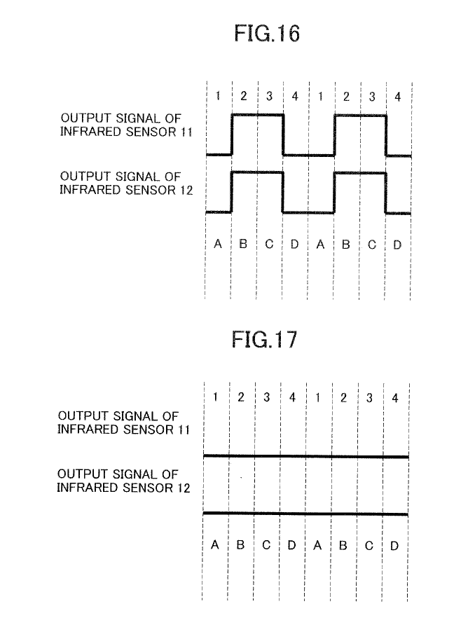

FIG. 13 is a schematic view illustrating an example in which the human body 51 enters into the detection target area of the infrared sensors 11 and 12 in FIG. 1. Herein, the human body 51 moves in the inside area from the left side of the outer peripheral area, and stands still therein. When the human body 51 moves toward the inside area from the outside of the detection target area, the human body 51 always passes through the outer peripheral area. Then, the human body 51 moves in the inside area after traveling through both of the outer peripheral area and inside area. FIG. 14 illustrates the output signals of the infrared sensors 11 and 12 when the human body 51 travels in the outer peripheral area under the condition indicated in FIG. 13. FIG. 15 illustrates the output signals of the infrared sensors 11 and 12 when the human body 51 travels through both of the outer peripheral area and inside area under the condition indicated in FIG. 13. FIG. 16 illustrates the output signals of the infrared sensors 11 and 12 when the human body 51 travels in the inside area under the condition indicated in FIG. 13. FIG. 17 illustrates the output signal of the infrared sensors 11 and 12 when the human body 51 stands still in the inside area under the condition indicated in FIG. 13.

The performance of the human body detector in FIG. 1 will be described as follows.

First, the electric device 10 enters into the static mode immediately after completing the initialization upon power-on. In the case in which the human body 51 already stands in the inside area at the time of power-on of the electric device 10, the sensor controller 13 sets the electric device 10 to the operating mode when the light amount change of the infrared rays which enter from one of the cell sections in the inside area is detected.

Next, an example in which the human body 51 does not stand in the inside area at the time of power-on, and the human body 51 enters into the inside area from the outside of the detection target area after the power-on will be described. In order to enter into the inside area, the human body must always pass through the outer peripheral area. Accordingly, when the human body enters into the inside area from the outside of the detection target area, the light amount change of the infrared rays which enter from two adjacent areas of the outer peripheral area is detected, and then the light amount change of the infrared rays which enter from one of the cell sections in the inside area is detected. When the above condition is satisfied, the sensor controller 13 determines the presence of the human body 51 in the inside area, and changes the static mode of the electric device 10 to the operating mode.

On the other hand, an example in which the human body travels away toward the outside of the detection target area from the inside area will be described. In this case, the human body always passes through the outer peripheral area. Therefore, when the human body travels away toward the outside of the detection target area from the inside area, the light amount change of the infrared rays which enter from one of the cell sections in the inside area is detected. Then, the light amount change of the infrared rays which enter from the adjacent two cell sections in the outer peripheral area is detected. The human body may move between the inside area and the outer peripheral area in a short period while using the electric device 10. In this regard, the repetition of mode change between the static mode and the operating mode in the electric device 10 causes lack of user-convenience. Therefore, the sensor controller 13 changes the mode of the electric device 10 from the operating mode to the static mode only in the case in which no light amount change of the infrared rays is detected in all cell sections for the predetermined period after the light amount change of the infrared rays which enter from the cell sections in the outer peripheral area is detected.

The following descriptions are made to summarize the above-described behavior.

FIG. 18 is a flow chart illustrating the human body-detecting process which is performed by the sensor controller 13 in FIG. 1. In Step S11, the power source of the electric device 10 is turned on. In Step S12, the sensor controller 13 sets the electric device 10 to the static mode. In Step S13, the sensor controller 13 determines whether the human body 51 is detected in the inside area or not. When the result is “YES”, the step proceeds to Step S14, and when the result is “NO”, the step proceeds to Step S18. In Step S14, the sensor controller 13 sets the electric device 10 to the operating mode. In Step S15, the sensor controller 13 determines whether the human body is detected in the outer peripheral area or not. When the result is “YES”, the step proceeds to Step S16, and when the result is “NO”, the step goes back to Step S14. In Step S16, the sensor controller 13 determines whether the human body is not detected for the predetermined period or not. When the result is “YES”, the step proceeds to Step S17, and when the result is “NO”, the step proceeds to Step S18. In Step S17, the sensor controller 13 sets the electric device 10 to the static mode. In Step S18, the sensor controller 13 determines whether the human body is detected in the outer peripheral area or not. When the result is “YES”, the step goes back to Step S13 and when the result is “NO”, the step goes back to Step S12.

The above-described human body-detecting method is summarized as follows. The sensor controller 13 determines that the human body continues to exist in the detection target area until the human body enters in the outer peripheral area again after moving toward the inside area from the outer peripheral area. The sensor controller 13 determines that the absence of the human body in the detection target area only in the case in which the light amount change of the infrared rays cannot be detected in all of the cell sections for a certain period after the human body passes toward the outer peripheral area from the inside area and moves away from the outer peripheral area.

The algorithm of the human body-detecting method shown in FIG. 13 is installed in the sensor controller 13.

The algorithm of the human body-detecting method shown in FIG. 13 may be modified as long as the movement between the inside area and the outer peripheral area can be detected.

According to the above-described human body-detecting method, the presence of the human body in the detection target area can be reliably detected.

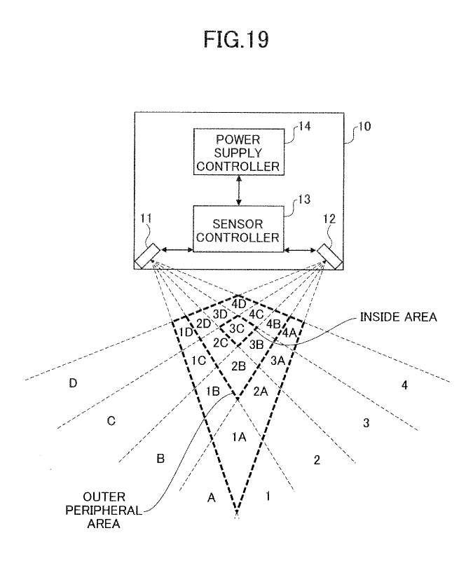

FIG. 19 is a block chart illustrating the configuration of the electric device 10 including the human body detector according to the modified example of the first embodiment of the present invention. The human body detector in FIG. 1 specifies the cell sections arranged along the portion adjacent to the electric device 10 in the outer periphery of the detection target area as they are not in the outer peripheral area but in the inside area, under the assumption that human body does not pass through such a portion. Therefore, the human body detector in FIG. 1 can keep the larger inside area. However, if the possibility in which the human body passes through the cell sections in such a portion can be considered, the cell sections where the human body may pass through can be detected as the cell sections in the outer peripheral area. The human body detector in FIG. 19 has a configuration in which an outer peripheral area and inside area are different from each other compared with the human body detector in FIG. 1. Referring to FIG. 19, the cell sections in the outer peripheral area are provided in all directions in relation to the inside area. The cell sections of the outer peripheral area are not limited to those in the examples shown in FIG. 1 and FIG. 19, but they may be arranged along the portion in the outer periphery of the detection target area where the human body can pass through.

In addition, the example in FIG. 1 includes the infrared sensor array in each of infrared sensors 11 and 12 arranged horizontally to the ground surface so that the detection target area can be expanded horizontally to the ground surface. The infrared sensors 11 and 12 can be arranged in any places and directions as long as the viewing fields of the infrared sensors 11 and 12 include the common area. For example, the infrared sensors 11 and 12 can be provided in the vertical direction to the ground surface.

In addition, the example in FIG. 1 includes each infrared sensor 11 and 12 including four infrared ray-sensing elements S1 to S4, but it may include another number of infrared ray-sensing elements.

The inside area is configured by a plurality of cell sections so that the coordinate can be assigned to each cell section. Therefore, the sensor controller 13 can determine the still standing position of the human body standing in the inside area, and determine the traveling direction of the human body in the inside area. By using such information, the sensor controller 13 may control the electric device 10 more accurately. For example, an example in which an illumination device is provided as the electric device 10 is described. In such a case, when the motion of the human body coming close to the illumination device in the inside area is detected, the human body detector can control the illumination to be brightened gradually. In reverse, when the motion of the human body moving away from the illumination device in the inside area is detected, the human body detector can control the illumination to be dimmed gradually.

### Second Embodiment

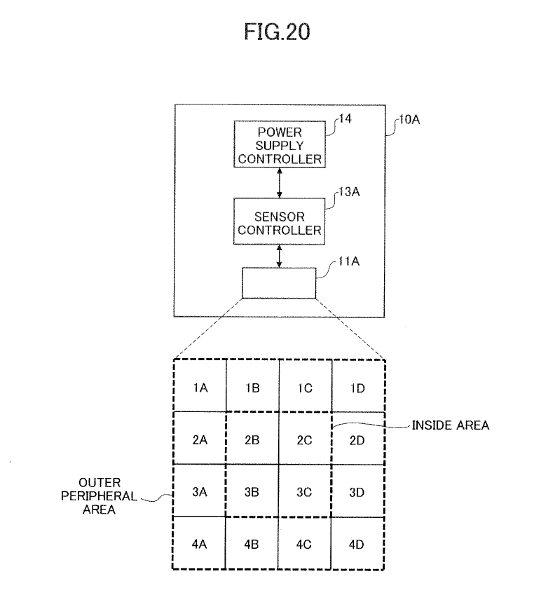

FIG. 20 is a block chart illustrating a configuration of an electric device 10A including the human body detector according to a second embodiment of the present invention. The electric device 10A includes a human body detector having an infrared sensor 11A and a sensor controller 13A, and a power supply controller 14. The human body detector is not always limited to include the infrared sensors 11 and 12 of two 1D infrared sensor arrays as shown in the figures. For example, it can include an infrared sensor 11A of a single 2D infrared sensor array. The infrared sensor 11A is configured to detect the light amount change of the infrared rays which enter from each of a plurality of cell sections which are formed by dividing the detection target area. The cell sections are provided two-dimensionally in the detection target area. The human body detector in FIG. 20 can perform the human body-detecting process as shown in FIG. 18 similar to the human body detector in FIG. 1.

### Third Embodiment

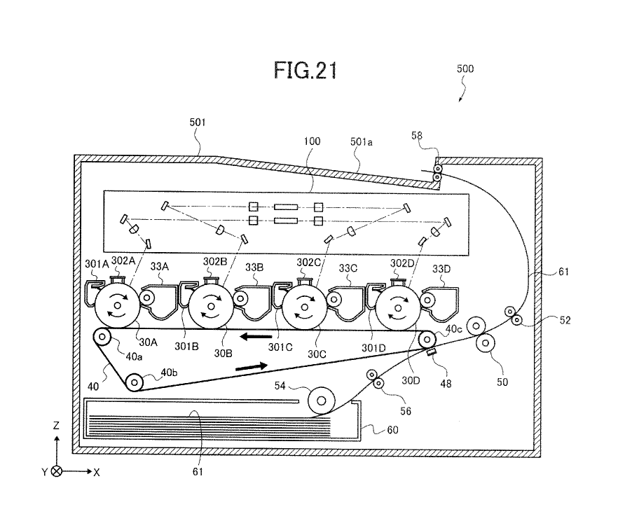

FIG. 21 provides an example of an image-forming apparatus 500.

The image-forming apparatus 500 is, for example, a tandem type color printer which prints multi-color images by superimposing and transferring black, yellow, magenta, and cyan color toner images onto sheets of paper. The image-forming apparatus 500 as shown in FIG. 21 comprises an optical scan apparatus 100, four photoconductive drums 30A to 30D, a transfer belt 40, a paper feed tray 60, a paper feed roller 54, a first resist roller 56, a second resist roller 52, a fuse roller 50, a paper discharge roller 58, a not-shown controller collectively controlling the respective components, and a housing 501 in a rectangular solid shape accommodating the components.

A paper discharge tray 501a on which printed sheets are discharged is formed on the top surface of the housing 501. The optical scan apparatus 100 is disposed under the paper discharge tray 501a.

The optical scan apparatus 100 scans the photoconductive drum 30A with a light beam for black image components modulated by image information supplied from a higher-level device (such as personal computer). Similarly, it scans the photoconductive drum 30B with a light beam for cyan image components, the photoconductive drum 30C with a light beam for magenta image components, and the photoconductive drum 30D with a light beam for yellow image components.

The four photoconductive drums 30A to 30D are cylindrical members and have photoconductive layers on their surfaces which become electrically conductive when illuminated with a light beam. They are disposed with an equal interval in an X-axis direction under the optical scan apparatus 100 in FIG. 21.

The photoconductive drum 30A is disposed at an end portion of a reverse X-axis direction (left side in FIG. 21) inside the housing 501 so that its longitudinal direction is to be the Y-axis direction. The photoconductive drum 30A is rotated by a not-shown rotation mechanism clockwise (as indicated by black arrows in FIG. 21). An electric charger 302A at the 12 o'clock position (upper side), a toner cartridge 33A at 2 o'clock position and a cleaning case 301A at the 10 o'clock position are disposed around the photoconductive drum 30A.

The electric charger 302A is disposed with a predetermined clearance over the surface of the photoconductive drum 30A with its longitudinal direction as the Y-axis direction. It electrically charges the surface of the photoconductive drum 30A with a predetermined voltage.

The toner cartridge 33A includes a cartridge body containing a toner of black image components and a developing roller charged with a voltage of reverse polarity of that of the photoconductive drum 30A, and the like. The toner cartridge 33A supplies the toner in the cartridge body to the surface of the photoconductive drum 30A via the developing roller.

The cleaning case 301A is provided with a cleaning blade of a rectangular shape with its longitudinal direction as the Y-axis direction, and it is disposed so that one end of the cleaning blade comes in contact with the surface of the photoconductive drum 30A. The toner adhering on the surface of the photoconductive drum 30A is removed by the cleaning blade along with the rotation of the photoconductive drum 30A and collected in the cleaning case 301A.

The photoconductive drums 30B, 30C, 30D with the same structure as that of the photoconductive drum 30A are placed in sequence on the right side of the photoconductive drum 30A with a predetermined interval. They are rotated by a not-shown rotation mechanism clockwise (as indicated by the black arrows in FIG. 21). Similarly to the photoconductive drum 30A, electric chargers 302B, 302C, 302D, toner cartridges 33B, 33C, 33D, and cleaning cases 301B, 301C, 301D are disposed around the photoconductive drums 30B, 30C, 30D, respectively.

The electric chargers 302B, 302C, 302D with the same structure as that of the electric charger 302A are disposed to electrically charge the surfaces of the photoconductive drums 30B, 30C, 30D with a predetermined voltage, respectively.

The toner cartridges 33B, 33C, 33D include cartridge bodies containing toners of cyan, magenta, yellow image components and developing rollers charged with a voltage of reverse polarity of that of the photoconductive drums 30B, 30C, 30D, and the like, respectively. The toner cartridges 33B, 33C, 33D supply the toners in the cartridge bodies to the surfaces of the photoconductive drums 30B, 30C, 30D via the developing rollers, respectively.

The structure and function of the cleaning cases 301B, 301C, 301D are the same as those of the cleaning case 301A.

Hereinafter, a unit of the photoconductive drum 30A, the electric charger 302A, the toner cartridge 33A, and the cleaning case 301A is to be referred to as the first image-forming station; likewise, a unit of the photoconductive drum 30B, the electric charger 302B, the toner cartridge 33B, and the cleaning case 301B as the second image-forming station, a unit of the photoconductive drum 30C, the electric charger 302C, the toner cartridge 33C, and the cleaning case 301C as the third image-forming station, and a unit of the photoconductive drum 30D, the electric charger 302D, the toner cartridge 33D, and the cleaning case 301D as the fourth image-forming station.

The transfer belt 40 is a free end ring-like member and rolls over driven rollers 40a, 40c placed under the photoconductive drums 30A, 30D, respectively, and rolls over a drive roller 40b which is placed at a slightly lower position than the driven rollers 40a, 40c. The upper end surface of the transfer belt 40 is in contact with the lower end surfaces of the photoconductive drums 30A, 30B, 30C, 30D. The transfer belt 40 is rotated counterclockwise (as indicated by the black arrows in FIG. 21) by counterclockwise rotation of the drive roller 40b. A transfer charger (transfer unit) 48 is applied with a voltage of a reverse polarity of that of the electric chargers 302A, 302B, 302C, 302D and is placed close to one end of the transfer belt 40 in the X-axis direction (right side in FIG. 21).

The paper feed tray 60 of a substantially rectangular solid shape is placed under the transfer belt 40 and contains stacked-up paper sheets 61 for printing. The paper feed tray 60 has a feeder outlet of a rectangular shape close to one end of the upper surface thereof in the X-axis direction (right side in FIG. 21).

The paper feed roller 54 extracts paper sheets 61 one by one from the paper feed tray 60 to feed them to a gap formed between the transfer belt 40 and the transfer charger 48 via the first resist roller 56 composed of a pair of rotary rollers.

The fuse roller 50 is composed of a pair of rotary rollers, and applies heat and pressure to the paper sheets 61 to feed the paper sheets 61 to the discharge roller 58 via the resist roller 52 composed of a pair of rotary rollers. The discharge roller 58 is composed of a pair of rotary milers and discharges the paper sheets 61 to the discharge tray 501a.

The image-forming apparatus 500 includes the human body detector according to the embodiments of the present invention.

The human body detector, human body-detecting method, electric device, and image-forming apparatus according to the embodiments of the present invention include configurations as follows.

According to a human body detector of the first aspect of the present invention, in the human body detector comprising an infrared sensor which detects a light amount change of infrared rays which enter from a detection target area, and a controller which determines the presence or absence of a human body in the detection target area according to the light amount change of the infrared rays,

the infrared sensor is configured to detect the light amount change of the infrared rays which enter from a plurality of cell sections which are formed by dividing the detection target area, and arranged two-dimensionally in the detection target area, and

the controller is configured to identify an outer peripheral area including cell sections provided along a portion in the outer periphery of the detection target area through which the human body can pass, and an inside area including cell sections other than those in the outer peripheral area, determine the presence of the human body in the detection target area when the light amount change of the infrared rays which enter from the cell sections in the inside area is detected, and determine the absence of the human body in the detection target area when the light amount change of the infrared rays is not detected for a predetermined period in all of the cell sections after the light amount change of the infrared rays which enter from the cell sections in the outer peripheral area is detected.

According to the human detector of the second aspect of the present invention, in the human body detector according to the first aspect,

the infrared sensor includes a first infrared sensor array including a plurality of first infrared ray-sensing elements having for each first viewing fields which are adjacent to and different from each other and a second infrared sensor array including a plurality of second infrared ray-sensing elements having for each second viewing fields which are adjacent to and different from each other,

each first viewing field intersects with each second viewing field one another, and

each cell section is a section in which one of the first viewing fields intersects with one of the second viewing fields.

According to the human body detector of the third aspect of the present invention, in the human body detector according to the second aspect,

the first infrared sensor array is configured so that the first viewing fields are formed by dividing the detection target area in a radial fashion, and

the second infrared sensor array is configured so that the second viewing fields are formed by dividing the detection target area in a radial fashion.

According to the human body detector of the fourth aspect of the present invention, in the human body detector according to the second or third aspect,

the first and second infrared sensor arrays are provided horizontally or vertically to a ground surface.

According to the human body detector of the fifth aspect of the present invention, in the human body detector according to any one of the first to fourth aspects,

the controller determines that the light amount of the infrared rays which enter from the cell sections in the outer peripheral area changes when the light amount change of the infrared rays is detected in a plurality of cell sections which are adjacent to each other in the cell sections in the outer peripheral area.

According to an electric device of the sixth aspect of the present invention, in the electric device including the human body detector according to any one of the first to fifth aspect,

the electric device has an operating mode and a static mode;

the controller sets the electric device to the operating mode when the controller determines the presence of the human body in the detection target area, and sets the electric device to the static mode when it determines the absence of the human body in the detection target area.

According to the electric device of the seventh aspect of the present invention, in the electric device including the human body detector according to the third aspect,

the electric device includes a chassis;

the first and second infrared sensor arrays are provided in the chassis with a predetermined distance therebetween;

the controller identifies the cell sections included in the first viewing field which is the most distant from the second infrared sensor array in a plurality of first viewing fields and the cell sections included in the second viewing field which is the most distant from the first infrared sensor array as the cell sections in the outer peripheral area, and identifies the cell sections other than those in outer peripheral area as the cell sections in the inside area,

the electric device has the operating mode and the static mode, and

the controller sets the electric device to the operating mode when it determines the presence of the human body in the detection target area, and sets the electric device to the static mode when it determines the absence of the human body in the detection target area.

An image-forming apparatus according to the eighth aspect of the present invention includes the human body detector according to the first aspect.

According to a human body-detecting method of the ninth aspect of the present invention, in the human body-detecting method which determines the presence or absence of a human body in a detection target area according to a light amount change of infrared rays which enter into an infrared sensor from the detection target area, the infrared sensor being configured to detect light amount change of the infrared rays which enter from a plurality of cell sections which is formed by dividing the detection target area, and arranged two-dimensionally in the detection target area,

the human body-detecting method comprises:

a step of identifying an outer peripheral area including cell sections which are provided along a portion in an outer peripheral of the detection target area through which the human body can pass, and an inside area including cell sections other than those in the outer peripheral area;

a step of determining the presence of the human body in the detection target area when the light amount change of the infrared rays which enter from the cell sections in the inside area is detected; and

a step of determining the absence of the human body in the detection target area when the light amount change of the infrared rays is not detected for a predetermined period in all cell sections after the light amount change of the infrared rays which enter from the cell sections in the outer peripheral area is detected.

The human body detector according to the embodiments of the present invention can be applied to an appropriate electric device in which the operating mode and the static mode can be switched in response to the presence of a human body. The electric devices include a printer complex machine and an illumination device. The human body detector according to the embodiments of the present invention can be also applied to an image-forming apparatus according to the third embodiment.

In accordance with the human body detector according to the present invention, the presence of the human body in the predetermined area can be reliably detected by using the infrared sensor.

Although the embodiments of the present invention have been described above, the present invention is not limited thereto. It should be appreciated that variations may be made in the embodiments described by persons skilled in the art without departing from the scope of the present invention.

What is claimed is:

1. A human body detector comprising an infrared sensor which detects a light amount change of infrared rays which enter from a detection target area, and a controller which determines the presence or absence of a human body in the detection target area according to the light amount change of the infrared rays, wherein
the infrared sensor is configured to detect the light amount change of the infrared rays which enter from a plurality of cell sections which are formed by dividing the detection target area, and arranged two-dimensionally in the detection target area, and
the controller is configured to identify an outer peripheral area including cell sections provided along a portion in the outer periphery of the detection target area through which the human body can pass, and an inside area including cell sections other than those in the outer peripheral area, determine the presence of the human body in the detection target area when the light amount change of the infrared rays which enter from the cell sections in the inside area is detected, and determine the absence of the human body in the detection target area when the light amount change of the infrared rays is not detected for a predetermined period in all of the cell sections after the light amount change of the infrared rays which enter from the cell sections in the outer peripheral area is detected.

2. The human body detector according to claim 1, wherein
the infrared sensor includes a first infrared sensor array including a plurality of first infrared ray-sensing elements having for each first viewing fields which are adjacent to and different from each other and a second infrared sensor array including a plurality of second infrared ray-sensing elements having for each second viewing fields which are adjacent to and different from each other,
each first viewing field intersects with each second viewing field one another, and
each cell section is a section in which one of the first viewing fields intersects with one of the second viewing fields.

3. The human body detector according to claim 2, wherein
the first infrared sensor array is configured so that the first viewing fields are formed by dividing the detection target area in a radial fashion, and
the second infrared sensor array is configured so that the second viewing fields are formed by dividing the detection target area in a radial fashion.

4. The human body detector according to claim 2, wherein
the first and second infrared sensor arrays are provided horizontally or vertically to a ground surface.

5. The human body detector according to claim 1, wherein
the controller determines that the light amount of the infrared rays which enter from the cell sections in the outer peripheral area changes when the light amount change of the infrared rays is detected in the plurality of cell sections which are adjacent to each other in the cell sections in the outer peripheral area.

6. An electric device comprising the human body detector according to claim 1, wherein
the electric device has an operating mode and a static mode;
the controller sets the electric device to the operating mode when the controller determines the presence of the human body in the detection target area, and sets the electric device to the static mode when it determines the absence of the human body in the detection target area.

7. An electric device comprising the human body detector according to claim 3, wherein
the electric device includes a chassis;
the first and second infrared sensor arrays are provided in the chassis with a predetermined distance therebetween;
the controller identifies the cell sections included in the first viewing field which is the most distant from the second infrared sensor array in a plurality of first viewing fields and the cell sections included in the second viewing field which is the most distant from the first infrared sensor array as the cell sections in the outer peripheral area, and identifies the cell sections other than those in outer peripheral area as the cell sections in the inside area,
the electric device has the operating mode and the static mode, and
the controller sets the electric device to the operating mode when it determines the presence of the human body in the detection target area, and sets the electric device to the static mode when it determines the absence of the human body in the detection target area.

8. An image-forming apparatus comprising the human body detector according to claim 1.

9. A human body-detecting method which determines the presence or absence of a human body in a detection target area according to a light amount change of infrared rays which enter into an infrared sensor from the detection target area, the infrared sensor being configured to detect the light amount change of the infrared rays which enter from a plurality of cell sections which is formed by dividing the detection target area, and arranged two dimensionally in the detection target area,
the human body-detecting method comprising:
a step of identifying an outer peripheral area including cell sections which are provided along a portion in an outer peripheral of the detection target area through which the human body can pass, and an inside area including cell sections other than those in the outer peripheral area;
a step of determining the presence of the human body in the detection target area when the light amount change of the infrared rays which enter from the cell sections in the inside area is detected; and
a step of determining the absence of the human body in the detection target area when the light amount change of the infrared rays is not detected for a predetermined period in all cell sections after the light amount change of the infrared rays which enter from the cell sections in the outer peripheral area is detected.
